(19) United States
(12) Patent Application Publication
(10) Pub. No.: US 2024/0367966 A1
(43) Pub. Date: Nov. 7, 2024

(54) GASIFIER OPTIMISED FOR THE PRODUCTION OF DIHYDROGEN WITH CO2 CAPTURE

(71) Applicant: Nicolas UGOLIN, Paris (FR)

(72) Inventors: Nicolas UGOLIN, Paris (FR); Ted SOUBDHAN, Saint-François (GP); Morgane MARY, Sainte-Luce (MQ); Kiliann Emma BOREL, Paris (FR); Yoann FEDOR, Vélizy Villacoublay (FR); Ghali EL BAROUDI, Massy (FR)

(21) Appl. No.: 18/576,166

(22) PCT Filed: Jul. 5, 2022
(86) PCT No.: PCT/FR2022/051344

§ 371 Date: Jan. 3, 2024

(30) Foreign Application Priority Data
Jul. 5, 2021 (FR) FR2107243

(51) Int. Cl. C01B 3/16

(52) U.S. Cl. CPC C01B 3/16; C01B 2203/0283; C01B 2203/0861; C01B 2203/0883; C01B 2203/1047; C01B 2203/1205

(57) ABSTRACT

The present invention relates to a device and a process for producing dihydrogen from CO and H₂O, by the water-gas shift reaction, characterized in that a gaseous mixture comprising CO and H₂O circulates in a reaction tube (1) with a diameter of between 5 mm and 500 mm and a length of between 50 mm and 10 m, disposed in a gasification reactor, and is subjected to at least one form of radiation, selected from electromagnetic radiation ranging from gamma rays to radio waves of more than 500 kHz, visible, infrared and ultraviolet or gamma radioactive waves, microwaves, and nuclear radiation such as alpha, beta and thermal radiation.

### TECHNICAL FIELD OF THE INVENTION

The production of dihydrogen (H₂) is a major challenge in the fight against global warming. In this context, a solution allowing the water-gas reaction or the reaction of the gas with water, with sequestration of all or part of the CO₂ produced, represents a competitive alternative for the production of dihydrogen. This alternative implements a tubular reactor 1, possibly lined with obstacles 2 in its lumen and using the energy of a gasification to initiate the reaction of the gas with the water.

### TECHNICAL BACKGROUND

The concerns about the global warming and climate change have triggered worldwide efforts to reduce the concentration of carbon dioxide (CO₂) in the atmosphere by limiting the fossil fuel energy consumption. Hydrogen or dihydrogen is an alternative energy source offering a flexibility of use comparable to that of fossil fuels. The main way put forward for producing dihydrogen is the water electrolysis.

The use of freshwater for carrying out this electrolysis poses the problem of the freshwater resources, which are likely to become scarcer in many regions as a result of global warming. A number of alternatives to the use of fresh water for electrolysis are also being developed, in particular the use of urine or salt water as a source of hydrolysis solution.

These alternative electrolysis solutions pose the problem of a premature electrode wear and therefore the use of noble metals such as gold or platinoids, which increase the cost of the equipment.

In addition, the electrolysis of solutions containing salts and other solutes can lead to the production of other products such as soda, chlorine, etc., which pose various environmental problems.

But beyond the hydrolysis solution used, the electrolyte, there is the problem of the energy source.

The hydrolysis of water is a very energy-intensive process with a positive enthalpy. The water decomposition reaction H₂O→H₂+½ O₂ requires an energy input of 180 KJ/mol.

Producing dihydrogen on a large scale using photovoltaic energy requires large surfaces to produce the necessary electrical energy, due to the low efficiency with which light energy is converted into electricity. In fact, despite the maximum yields of 24% announced for the new generations of photovoltaic cells, the current yields are barely reaching 16%. Moreover, the manufacture of the photovoltaic cells is highly polluting, particularly in terms of CO2 emissions. For most photovoltaic panels, it takes several years of operation to offset the greenhouse gas emissions generated during the manufacture. Furthermore, this compensation will only take the form of a gas emission avoidance and not a CO2 emission capture or a greenhouse gas sequestration.

Hydrogen produced by electrolysis from nuclear electricity is increasingly being promoted. Notwithstanding the cost of manufacturing a nuclear power plant and especially the cost in terms of CO₂ emissions of building the plant (concrete, steel, earthworks), which are omitted in the calculation of CO₂ emissions for the nuclear power generation, the manufacture of nuclear fuel as well as the recycling of the waste and its storage represent a significant cost in terms of CO₂ emissions. Uranium extraction is part of mining activities, which account for 53% of the greenhouse gas emissions of the world. Taking in consideration the nuclear industry as a whole, it would appear that the industry is not as carbon-neutral as the professionals from the field claims.

Moreover, the nuclear energy essentially produces electricity continuously and in an adapted manner to the demand, unlike the alternative renewable energies, which require storage in order to meet the demand.

As a result, the relevance of switching from nuclear electricity to hydrogen to produce electricity again, with a loss of between 66% and 30% depending on the technology implemented, is not immediately obvious.

Numerous projects present the use of wind energy to produce hydrogen by electrolysis as a viable alternative. However, to meet the demand it would be necessary to build massive projects, which would pose a number of environmental problems. In particular, because of the dispersed nature of the wind energy resource, to produce 1 kWh from wind power you need to install facilities that use 100 times more steel and metals than to produce 1 kWh from nuclear power.

It appears that the electrolysis to produce the hydrogen without emitting CO2 of fossil origin is highly limited in terms of technology, water and energy resources.

The technologies for producing dihydrogen from hydrocarbons or coal, using various thermolysis technologies such as cracking, gasification, etc., involving high temperatures, high pressures and/or oxidants such as water, pose the problem of significant emissions of greenhouse gases such as methane and CO₂ of fossil origin.

Similarly, the production of dihydrogen from biomass, or of carbon from biomass, using the same or thermolysis technologies of similar technologies, emits CO₂ and other greenhouse gases, which are certainly renewable, but which transform stored carbon from a solid matrix into atmospheric carbon in the form of CO2, CH4, which in the short term makes a major contribution to global warming. In fact, it will take several months, or even several years, to store the same mass of carbon sustainably through the growth of the various biomasses, provided that said biomass is replanted and its growth comes to an end.

In addition, the thermolysis technologies for producing dihydrogen pose the problem of the separation of the gases. The dihydrogen produced is mixed with other gases such as CO₂ and CO.

Lastly, these thermolysis technologies require large quantities of energy, which poses the problem of economic viability, since the high temperatures mean that a significant proportion of the hydrogen produced has to be used to produce the energy required.

Based on improvements to a cyclonic reactor, the principle of which has already been described (Ugolin 2007), we propose a new gasification cycle, allowing to capture in solid form all or part of the carbon coming from the carbonaceous substrate being treated (biomass coal, oil, ouch, etc.), while isolating the dihydrogen produced.

The principle of the gasifier already presented is based initially on a reactor composed of a system of cyclones connected together according to the model.

Each cyclone confines one type of gasification reaction to a dedicated reaction space. The substrate, in the form of carbon particles, is introduced longitudinally into the various cyclones, while the oxidants are introduced laterally and tangentially to the cylinder of the cyclone. The oxidants can be introduced by means of a plasma torch nozzle so as to form a plasma in the cyclone. The cyclonic structure reaction site allows:
Bringing particles into contact with the particular oxidising agent at high temperature for a sufficiently long time to promote the mass and heat transfer so that the selected thermochemical reactions take place in the majority.
Separating the partially or fully gasified solid substrate for transferring it to a lower stage through fins
Recovering the reacted gas in a rising column.

In some embodiments of the device, the gases being collected at each step through a collection device located at the top position of the cyclone. In other embodiments, the collection tubes of the assembly of the cyclones are aligned with each other so that the columns of gas rising in a cyclone rise in the upper cyclone and merge with the own column of gas rising from the upper cyclone, so that the column of gas rising from all the cyclones of the reactor can be captured by the gas capture cylinder rising from the first cyclone.

In these embodiments, there was a high risk of gas leaking from one stage to another through the set of vanes between the reactors. On the other hand, the positioning of the capture channels in a top position posed particular aerodynamic problems that disrupted the operation of the cyclone.

Finally, the reactor as described has no means for separating and purifying the gases produced, such that the reactor produces a mixture of at least two molecules chosen from CO, H₂, CO₂, H₂O.

In particular, the device does not have elements for automatically carrying out the gas-water reaction
such that CO+H₂O→CO₂+H₂
Nor does the device automatically separate CO₂ from dihydrogen H₂

### SUMMARY OF THE INVENTION

The present invention relates to a device and a method for producing dihydrogen from CO and H₂O, according to the gas-water reaction:

CO+H₂O→CO₂+H₂, (a)
characterised in which a gas mixture comprising CO and H₂O circulates in a reaction tube (1) with a diameter of between 5 mm and 500 mm, and a length of between 50 mm and 10 m, arranged in a gasification reactor, and is subjected to at least one radiation, selected from an electromagnetic radiation ranging from gamma rays to radio waves greater than 500 kHz, via visible infrared and ultraviolet waves or radioactive gamma, microwave, nuclear radiation such as alpha, beta or thermal radiation.

The device or the method according to the invention may comprise one or more of the following characteristics or steps, taken in isolation from one another or in combination with one another:
the reaction tube comprises at least one portion preferably made of quartz, borosilicate glass, refractory metal such as inconel, nickel or any other refractory metal, ceramics as carbide for example silicon, iodide, zirconia carbide, and in that the reaction tube is partly included in a gasification reactor;
the inside of the reaction tube comprises, on its internal surface, catalysts which catalyse said reaction (a), such that these catalysts comprise metals chosen from: iron in the form of an oxide, Fe+, Fe2+, Fe3+, titanium in the form of an oxide, cobalt in the form of an oxide, nickel in the form of an oxide, platinoids and platinoid oxides, and a combination of these metals;
the reaction tube comprises in its lumen a set of obstacles (2), possibly covered with catalyst, preferably arranged perpendicularly to the main axis of the reaction tube, such that by circulating through the lumen of the reaction tube, a CO/H₂O mixture comes into contact with these obstacles, promoting the reaction of the gas with the water;
the reaction tube passes through at least one waveguide into which microwaves produced by a magnetron are injected, such that the action of the microwaves on the reaction tube, by a thermal action and in the reaction tube, by a thermal and molecular agitation action, promotes said reaction (a) of gas with water;
said reaction (a) is activated by increasing the temperature of the reaction tube by applying to its surface or directly inside the reaction tube, an electromagnetic radiation in the ultraviolet to infrared range, said radiation being applied by at least one optical fibre preferably comprising a quartz or borosilicate portion;
the reaction tube is subjected to a variable electric and magnetic field produced by a solenoid of 3 to 7 turns, in which an alternating current of between 800 kHz and 20 MHz circulates, and in that the inductive variable magnetic field produces a reaction plasma in a CO/H₂O gas passing through the reaction tube, promoting said reaction (a);
the reaction tube is arranged in a device combining at least two of the devices described above, allowing any combination of microwave, light wave and inductive magnetic field application to the reaction tube;
the reaction tube (1) passes through at least one cyclonic gasification reactor so that the radiative thermal heat of the cyclonic gasification reactor, resulting from at least one of the gasification reactions:

C+H₂O→CO+H₂ (b)

C+CO₂→2CO (c)

C+½ O₂→CO (d)
heating said reaction tube, and such that the cyclonic gasification reactor comprises at least one cylinder, forming the body of the gasification reactor, which narrows into a cone in the bottom of the gasification reactor, such as the gases injected into the gasification reactor, form a vortex descending along the cylindrical wall of the cyclone, said vortex by convection under the action of the conical shape of the bottom of the cyclone, rises in the centre of the cyclone, and in that the cyclonic gasification reactor comprises a cyclonic device with at least two inlets, one of which is longitudinal and the other tangential, and comprises at least one extraction device for extracting materials from the conical portion at the bottom of the cyclone;
at least one longitudinal inlet of the cyclonic gasification reactor comprises a double set of propellers, preferably a movable set attached to the reaction tube, acting as the central axis of rotation for the cyclonic gasification reactor, and another set of stationary propellers, the double set of propellers allowing the materials to enter the cyclonic gasification reactor by confining the gases circulating in the cyclonic gasification reactor;
the cyclonic gasification reactor comprises at least one waveguide allowing microwaves to be injected into the cyclonic gasification reactor, such that the orientation of the waveguides is optimised so that the trajectory of the microwaves crosses that of the plasma injected into the cyclonic gasification reactor by at least one plasma torch, allowing the microwaves to interact with the plasmas injected by the plasma torches, while minimising the interaction with a column of gas rising in the cyclone;
an extraction device comprises any combination of an endless screw, a central hub mill, a hollow endless screw, a hollow central hub mill, alternatively any combination of a collector tube and optionally hollow vanes, a cap forming a plug with a system of conduits;
an element is introduced at the level of a wall of the cyclonic gasification reactor, this element preferably being made of ceramic and having a system allowing to regulate the temperature of the ceramic in order to set its temperature at a determined level so as to transform said ceramic into an adjustable black body emitting an infrared radiation of a selected wavelength, and in that the wavelength emitted by the black body is adjusted by controlling the temperature of the black body by a heating device and a cooling thermal exchanger;
at least one wall of the cyclonic gasification reactor incorporates at least one thermal exchanger, cooled by a fluid such as water or a mixture of gasification oxidising gases such as H₂O, CO₂, O₂;
the oxidising vapours produced in the exchanger included in the wall of the cyclonic gasification reactor, and the gasification products resulting from said gasification reactions (b), (c), and (d), are injected into the reaction tube so as to convert the CO produced into CO₂ and H₂;
the device or the method allows to inject a gas comprising CO into a plasma reactor in order to carry out a reaction:

2 CO→CO₂+C, (e)
characterised in that the reactor is a plasma cyclonic tube, comprises:
a tube transparent to the microwaves, permeable to an electric and magnetic field while being electrically insulating, such as quartz, alumina, zirconia, borosilicate or iodide, with a diameter of between 1 cm and 10 cm, preferably 4 cm,
at least one waveguide allowing to apply microwaves inside the tube transparent to the microwaves,
in the lower portion of the tube transparent to the microwaves, there is a cone pierced by a hole through which an axle can pass,
an adjustable electrically conductive axle, such as graphite recoated with a platinum metal, stainless steel optionally covered with gold or silver,
a fine propeller made of conductive material, with a diameter equal to the cross-section of the gas column rising in the plasma cyclonic tube, typically 33% of the internal diameter of the tube, which is electrically connected to earth temporarily,
in the top position of the tube, a cover whose internal edge is continuous with the inner wall of the tube transparent to the microwaves, having an orifice tangential to the inner wall of the cover allowing a gas to be injected tangentially to said wall of the cover,
in the centre of the cover a central collection tube whose internal diameter is equal to the size of the rising gas column, typically 33% of the internal diameter of the tube transparent to the microwaves,
a solenoid, preferably between 3 and 7 turns, connected to the terminals of a high-frequency generator, for example between 800 kHz and 20 MHz;
the collector tube of a cyclone of a cyclonic gasification reactor, confluent with the hollow endless screw of the extractor of a second cyclone above the first cyclone, is closed at its upper end by a cap forming a plug with a system of conduits also forming the bottom of the upper cyclone, the vanes disposed around the tube, confluent with the lumen of the endless screw, being hollow and open at one of their ends into the lumen of the tube and at the other of their ends outside the cyclonic gasification reactor, so that the gases rising from the lower cyclone are captured and conducted through the vanes through a reservoir outside the cyclone to be captured there;
a reaction tube is secured to a hollow-walled coreless propeller/endless screw, such that the reaction tube forms the axle of the propeller, said propeller and the reaction tube being embedded in a linear tube gasification reactor, such that the outer wall of the linear tube gasification reactor comprises at least one thermal exchanger, and such that a heat-transfer fluid, preferably the oxidising fluid used for the gasification, circulates in the at least one exchanger so that said fluid is heated by the gasification reactions occurring in the linear gasification reactor, and such that in a preferred embodiment, the heat-transfer fluid at the outlet of the at least one exchanger is injected into the hollow walls of the propeller, which is pierced with holes allowing to diffuse the heat-transfer fluid towards waveguides regularly arranged more or less perpendicular to the main axis of the line-tube gasification reactor, in regions where the line-tube gasification reactor is made of a material transparent to the microwaves, such as ceramic quartz of zirconium, nitride or alumina, and in a preferred embodiment, the reaction tube, forming the axle of the propeller, is also made of a material transparent to the microwaves;
optical fibres are regularly arranged along the linear tube gasification reactor, close to the waveguides, so as to inject the electromagnetic radiation, preferably light such as UV, visible or infrared radiation, onto and preferably into the linear tube gasification reactor and onto and into the reaction tube;
after each waveguide and optionally each set of optical fibres, a gas extraction unit is installed in the linear tube gasification reactor, such that each gas extraction unit comprises at least one cylindrical filter isolated upstream and downstream by a system of tesla valves mounted in opposition.

This invention also relates to a device for producing dihydrogen from CO and H₂O, according to the gas-water reaction:

CO+H₂O→CO₂+H₂, (a)

characterised in that it comprises:
a reaction tube in which a gas mixture comprising CO and H₂O is intended to circulate, this reaction tube having a diameter of between 5 mm and 500 mm, and a length of between 50 mm and 10 m,
a first gasification reactor in which the reaction tube is disposed so as to subject the reaction tube to a first thermal energy generated in operation by the first gasification reactor, and
least one device for subjecting the reaction tube to at least one second electromagnetic energy, chosen from an electromagnetic radiation ranging from gamma rays to radio waves above 500 kHz, a radiation in the visible infrared and ultraviolet waves, a gamma radiation, a microwave radiation and a nuclear radiation such as alpha and beta.

The device or the method according to the invention may comprise one or more of the following characteristics or steps, taken in isolation from one another or in combination with one another:
the reaction tube comprises at least one portion preferably made of quartz, borosilicate glass, refractory metal such as inconel, nickel or any other refractory metal, ceramics such as carbide for example silicon, iodide, zirconia carbide;
the inside of the reaction tube comprises on its internal surface catalysts configured to catalyse said reaction (a), such that these catalysts comprise metals chosen from: iron in oxide form, Fe+, Fe2+, Fe3+, titanium in oxide form, cobalt in oxide form, nickel in oxide form, platinoids and platinoid oxides, and a combination of these metals;
the reaction tube comprises an internal lumen in which a set of obstacles, possibly covered with catalysts, is arranged, preferably perpendicular to the main axis of the reaction tube, such that, as it circulates through the lumen of the reaction tube, a CO/H₂O mixture comes into contact with these obstacles, promoting the reaction of the gas with the water;
the device comprises at least one waveguide configured to inject microwaves produced by a magnetron into the reaction tube in order to promote said reaction (a) of gas to water by a thermal and molecular agitation action;
the device comprises at least one optical fibre preferably comprising a quartz or borosilicate portion, and configured to apply to the surface of the reaction tube or directly inside the reaction tube, an electromagnetic radiation between ultraviolet and infrared, in order to activate said reaction (a) by increasing the temperature of the reaction tube;
the device comprises a solenoid of 3 to 7 turns, in which an alternating current of between 800 kHz and 20 MHz is intended to circulate, and configured to subject the reaction tube to an inductive electric and magnetic field, and to produce a reaction plasma in the CO/H₂O gas passing through the reaction tube, in order to promote said reaction (a);
the reaction tube is disposed in a device combining at least two of the devices selected from below, and allowing any combination of microwave, light wave and inductive magnetic field application to the reaction tube:
   at least one waveguide configured to inject microwaves produced by a magnetron into the reaction tube,
   at least one optical fibre configured to apply an electromagnetic radiation in the ultraviolet to infrared range to the surface of the reaction tube or directly inside the reaction tube,
   a solenoid having from 3 to 7 turns, in which an alternating current of between 800 kHz and 20 MHz is intended to circulate, and configured to subject the reaction tube to an inductive electric and magnetic field, and to produce a reaction plasma in the CO/H₂O gas passing through the reaction tube;
said gasification reactor is a cyclonic reactor which is configured so that the radiative thermal heat of the cyclonic gasification reactor, resulting from at least one of the gasification reactions:

C+H₂O→CO+H₂ (b)

C+CO₂→2CO (c)

C+½ O₂→CO (d)
heats said reaction tube, and such that the cyclonic gasification reactor comprises:
   at least one cylinder, forming the body of the gasification reactor, which narrows into a cone at the bottom of the gasification reactor, such that the gases injected into the gasification reactor form a vortex descending along the cylindrical wall of the cyclone, said vortex by convection under the action of the conical shape of the bottom of the cyclone, rises at the centre of the cyclone,
   a cyclonic device with at least two inlets, one longitudinal and one tangential, and
   at least one extraction device for extracting material from the conical portion at the bottom of the cyclone;
said reactor comprises at least one longitudinal inlet comprising a double set of propellers, preferably a first set of movable propellers attached to the reaction tube and configured to act as a central axis of rotation for the cyclonic gasification reactor, and another set of stationary propellers, the double set of propellers allowing materials to enter the cyclonic gasification reactor by confining the gases circulating in the cyclonic gasification reactor;
the gasification reactor comprises:
   at least one waveguide allowing to inject microwaves into the gasification reactor, and
   at least one plasma torch in the gasification reactor,
such that the orientation of said at least one waveguide is optimised so that the trajectory of the microwaves crosses that of the plasma injected into the gasification reactor by at least one plasma torch, allowing the microwaves to interact with the plasmas injected by said at least one plasma torch, while minimising the interaction with a column of gas rising in the gasification reactor;
the device further comprises an extraction device comprising any combination of an endless screw, a central hub mill, a hollow endless screw, a hollow central hub mill, and alternatively any combination of a collector tube and possibly hollow vanes, and a cap forming a plug with a system of conduits;
an element is introduced at the level of a wall of the gasification reactor, this element preferably being made of ceramic and having a system allowing to regulate the temperature of the ceramic in order to set its temperature at a determined level so as to transform said ceramic into an adjustable black body emitting an infrared radiation of a selected wavelength, and in that the wavelength emitted by the black body is adjusted by controlling the temperature of the black body by a heating device and a cooling thermal exchanger;
at least one wall of the gasification reactor incorporates at least one thermal exchanger, cooled by a fluid such as the water or a mixture of gasification oxidising gases such as H₂O, CO₂, O₂;
said at least one thermal exchanger is configured to produce oxidising vapours, which are, together with the gasification products resulting from said reaction (b), (c), and (d), injected into the reaction tube so as to convert the CO produced into CO₂ and H₂;
this device allowing a gas comprising CO to be injected into a plasma reactor in order to carry out a reaction:

2 CO→CO₂+C, (e)
characterised in that the reactor is a plasma cyclonic tube, and comprises:
   a tube transparent to the microwaves, permeable to an electric and magnetic field, and electrically insulating, such as quartz, alumina, zirconia, borosilicate, iodide, this tube having a diameter of between 1 cm and 10 cm, and preferably 4 cm,
   at least one waveguide allowing to apply microwaves inside the tube transparent to the microwaves,
   a cone pierced with a hole letting the passage of an axle at the bottom portion of the tube transparent to the microwaves,
   an adjustable electrically conductive axle, such as graphite covered with a platinum metal, or stainless steel, and optionally covered with gold or silver,
   a fine propeller of conductive material, with a diameter equal to the cross-section of the gas column rising in the plasma cyclonic tube, and typically having a diameter corresponding to 33% of the internal diameter of the tube, this fine propeller being intended to be electrically connected to earth temporarily,
   in the top position of the tube, a cover whose internal edge is continuous with the inner wall of the tube transparent to the microwaves, this cover having an orifice tangential to the inner wall of the cover allowing a gas to be injected tangentially to said wall of the cover,
   in the centre of the cover a central collection tube whose internal diameter is intended to be equal to the size of the rising gas column, and typically having a diameter corresponding to 33% of the internal diameter of the tube transparent to the microwaves, and
   a solenoid with preferably between 3 and 7 turns, which is connected to the terminals of a high-frequency generator, for example between 800 kHz and 20 MHz.
the device comprises:
   a collector tube in the gasification reactor,
   a hollow endless screw of an extractor of a second reactor located above the first reactor is closed at its top end by a cap forming a plug with a system of conduits also forming the bottom of the second reactor,
   hollow vanes arranged around the tube, confluent with the endless screw, and open at one of their ends into the tube and at the other of their ends to the outside of the second reactor so that the gases rising from the first reactor are captured and conducted through the vanes towards a reservoir towards the outside;
the reaction tube is secured to a hollow-walled propeller or a coreless endless screw, such that the reaction tube forms the axle of the propeller or of the endless screw, this propeller or endless screw and the reaction tube being embedded in the gasification reactor, and in that the outer wall of the gasification reactor comprises at least one thermal exchanger, so that a heat-transfer fluid, preferably the oxidising fluid used for the gasification, circulates in said at least one exchanger so that said fluid is heated by gasification reactions occurring in the gasification reactor, and such that in a preferred embodiment the heat-transfer fluid at the outlet of the at least one exchanger is injected into hollow walls of the propeller which is pierced with holes, to allow the heat-transfer fluid to be diffused in relation to waveguides regularly arranged more or less perpendicularly to the main axis of the gasification reactor, in regions where the gasification reactor is made of a material transparent to the microwaves, such as ceramic quartz of zirconium, nitride or alumina, and in a preferred embodiment the reaction tube forming the axle of the propeller or of the endless screw is also made of a material transparent to the microwaves;
optical fibres are regularly arranged along the gasification reactor, close to waveguides, so as to inject electromagnetic radiation, preferably light such as UV, visible or infrared, onto and preferably into the gasification reactor and onto and into the reaction tube;
the device comprises a gas extraction unit implanted in the gasification reactor after at least one waveguide and possibly after a set of optical fibres, each gas extraction unit comprising at least one cylindrical filter isolated upstream and downstream by a system of tesla valves mounted in opposition.

### BRIEF DESCRIPTION OF THE FIGURES

Further characteristics and advantages of the invention will become apparent from the following detailed description, for the understanding of which reference is made to the attached drawings in which:

FIG. 1 shows a reaction tube with devices for subjecting the tube to electromagnetic radiation (microwaves, varying magnetic fields, UV light, visible infrared), I) seen from the side, II) seen from above with two waveguides crossed at an angle α;

FIG. 2 shows a reaction tube passing through a cyclonic gasification reactor: I) side view, II) top view;

FIG. 3 shows I) an implantation of waveguides and plasma torches, and II), III), IV) various material extraction devices arranged in a cone of a cyclonic gasification reactor with central hub, endless screw, vanes or fins respectively;

FIG. 4 shows an adjustable black body I) integrated into the cyclone of a cyclonic gasification reactor, II) seen from the side, and III) seen from the front;

FIG. 5 shows a device for bubbling and trapping CO₂ by the formation of hydroxy metal;

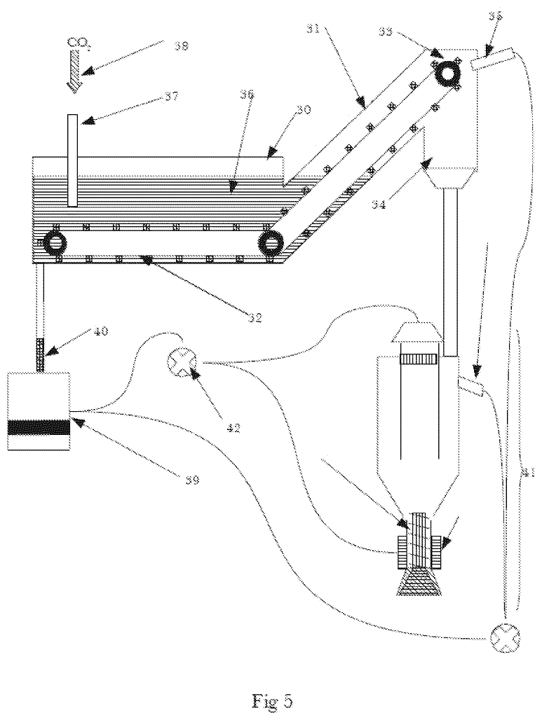

FIG. 6 shows a cyclonic gasification reactor (gasifier) with three stages and a central reaction tube;

FIG. 7 shows a plasma tube device for condensing CO onto itself;

FIG. 8 shows an example of a two-stage cyclonic gasification reactor with a hollow extractor confluent with a central collection tube for collecting the rising gases;

FIG. 9 shows a gas recovery plug placed in the cone of the cyclone of a gasifier;

FIG. 10 shows a linear tube gasification reactor with endless screw or hollow propeller and a reaction tube;

FIG. 11 shows an example of the longitudinal inlet of a cyclonic gasification reactor, with an inlet conveyor in the form of a slide or movable propeller, and two sets of vanes or fins, one of which is movable and forms the longitudinal inlet;

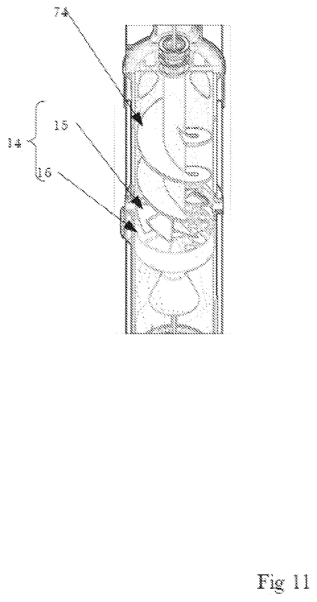

FIG. 12 shows a chemical equation involved, an energy balance for neutralising CO₂ emissions and an adjustable gasification cycle, limiting or absorbing CO₂ depending on the energy involved;

FIG. 13 shows a device according to the invention comprising a reaction tube in a gasification reactor; and

FIG. 14 illustrates an example of how the invention works.

### DETAILED DESCRIPTION OF THE INVENTION

1) Method for implementing the reaction “a)” of gas with water:

CO+H₂O→CO₂+H₂ a)
exothermic reaction ΔH=−40 kJ·Mol⁻¹
characterised by the circulation of a mixture of CO and H₂O in a reaction tube 1 with a diameter of between 5 mm and 100 mm, a length of between 100 mm and 10 m, and comprising at least one portion preferably made of quartz, borosilicate glass, refractory metal such as inconel, nickel or any other refractory metal, ceramics such as carbide for example silicon, iodide, zirconia carbide or any other ceramic or material resistant to high temperatures and oxidising media, such that the reaction tube is integrated into a gasification reactor and is subjected to a radiation or a combination of radiations, chosen from:
   the electromagnetic radiation ranging from gamma rays to the radio waves above 500 kHz, including visible infrared and ultraviolet waves, active gamma rays and microwaves,
   a nuclear radiation such as alpha or beta,
   a thermal radiation,
allowing the reaction “a” to take place at a temperature above 750° C.
2) In a particular embodiment, the inside of the reaction tube comprises on its internal surface catalysts capable of catalysing the reaction “a”, such that these catalysts comprise:
   1) iron oxides in the form of Fe+, Fe2+, Fe3+,
   2) titanium oxides, cobalt oxides, nickel oxides,
   3) platinoids such as platinum, palladium . . . .

A combination of these oxides or any other catalyst capable of catalysing reaction “a” at a temperature preferably between 200° C. and 1000°° C.
3) In a particular embodiment, a set of obstacles 2, possibly covered with catalyst, will be arranged in the lumen of the reaction tube in a direction perpendicular to the main axis of the reaction tube, such that as it circulates through the lumen of the reaction tube, the CO/H₂O mixture comes into contact with these obstacles, promoting the reaction “a”.

In an even more preferred embodiment, the obstacles 2 will consist of a bar with a diameter of between 100 μm and 5 mm. The obstacles will be made of ceramic such as zirconium, silicon carbide or any other ceramic.

In an even more specific embodiment, the obstacles 2 are made of an electrically conductive material such as silicon carbide, platinum oxide or other platinum covered metals.

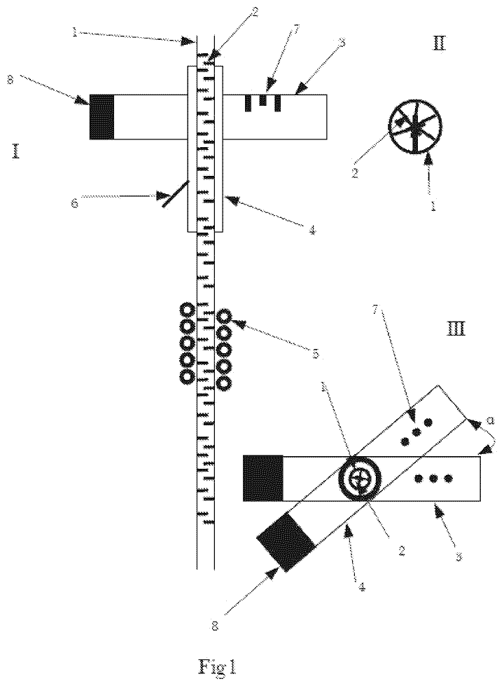

In some embodiments, the obstacles 2 are made of conductive materials, while the reaction tube is made of an electrically insulating material.
4) In some embodiments, the obstacles 2 are preferably implanted along a helical generatrix FIG. 1-I.2 along the reaction tube.

In other embodiments, several sets of obstacles 2 may be arranged in the lumen of the reaction tube along several overlapping helical generatrixes, with each set of obstacles following a given generatrix.

In other embodiments, the obstacles 2 will be covered by a plurality of catalysts such that each obstacle is covered by a given catalyst, the catalysts being different between the obstacles or a given mixture of catalysts.
5) In a particular embodiment, the reaction tube is subjected to microwaves such that the reaction tube is arranged perpendicular to the main axis of a waveguide 3, into which microwaves are injected, for example produced by a magnetron. In this embodiment, the reaction tube is made of a material transparent to the microwaves, such as ceramic with zirconium, alumina, quartz, borosilicate glass, etc.
6) In a particular embodiment, the waveguide 3 comprises several tuning elements allowing to tune the incident and reflected waves so as to deposit the maximum power in the reaction tube. In particular, the adjustment elements comprise a movable piston 8 and adjustment bars 7.
7) In some embodiments, the reaction tube 1 will be arranged at the intersection of at least two waveguides FIG. 1.III.3 spaced apart by an angle a, into which waves are injected, such that the angle a allows the microwaves to cross at the level of the reaction tube and such that the adjustment of the tuning elements 7-8, in particular the phasing elements, allows to obtain a constructive wave inside the reaction tube, by superimposing the waves coming from the at least two sources. The action of the microwaves and possibly of the catalysts allows to promote the reaction “a”. In particular, by inducing the formation of a plasma in the CO/H₂O mixture passing through the reaction tube.

In a particular embodiment, the waveguides are connected to a containment cylinder 4 through which the reaction tube passes, such that the containment tube forms a preferably hermetic enclosure with the wall of the reaction tube. The waveguides opening into the containment tube may be obstructed upstream and downstream of the containment tube by a window transparent to the microwaves, for example made of quartz, borosilicate or any other material transparent to the microwaves, so that the microwaves can be applied to the reaction tube.

In other embodiments, the reaction “a” will be activated by increasing the temperature of the reaction tube by applying to its surface or directly inside the reaction tube, an electromagnetic radiation comprised in the ultraviolet to infrared range, possibly packaged in an optical fibre 6 comprising a quartz or borosilicate portion. The optical fibres 6 will preferably be inserted into a sealed containment cylinder 4 through which the reaction tube 1 passes, so that the light emitted by the optical fibres illuminates and heats the reaction tube 1 or the inside of the reaction tube.

In one particular embodiment, the internal face of the containment cylinder 4 will be made of a light-reflecting material, such as polished or mirrored metal. In this particular embodiment, the fibres 6 are preferably implanted at an angle other than 90° relative to the axis of the reaction tube, so as to limit the reflections that send light back into the optical fibres.

In a preferred embodiment, the optical fibres 6 will transport sunlight concentrated in the fibre by solar concentration.
8) In one embodiment, a reaction tube is arranged at the centre of a solenoid 5, for example a solenoid with 5 turns in which an alternating current of between 800 kHz and 30 MHz circulates, so as to produce a variant inductive magnetic field capable of producing a reaction plasma in the CO and H₂O gases passing through the reaction tube, so as to promote the reaction “a”.

In a particular embodiment, the solenoid will be made in a metal tube, such as copper, gold alloy, silver alloy or a mixture of these materials which may include plating of these materials, and such that a heat-transfer liquid passes through the solenoid tube to cool said solenoid.

In one particular embodiment, any combination of microwaves, light waves and inductive magnetic field is applied to the reaction tube. In particular, the containment cylinder 4 can contain both waveguides and optical fibres, allowing microwaves and visible electromagnetic waves to be introduced at the same level.
9) In a particular embodiment, the reaction tube 1 passes through a cyclonic gasification reactor 9 so that the radiative thermal heat of the gasification reactions allows to initiate the reaction “a”.

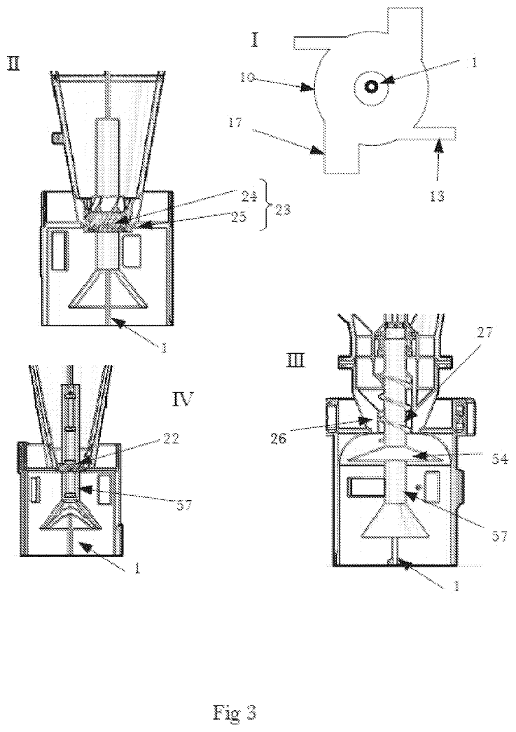

The cyclonic gasification reactor comprising a cylinder 10 forming the body of the cyclone which narrows to a cone 11 at the bottom of the reactor, such that the gases injected into the reactor form a downward vortex along the wall of the cylinder of the cyclone, which by convection under the action of the cone shape 11 at the bottom of the cyclone, rises to the centre of the cyclone.
10) In a particular embodiment, the cyclonic reactor comprises a cyclonic device with two longitudinal inlets 12 and a tangential inlet 13. For example, a longitudinal inlet, made up of a double set of fins 14, of which a movable set 15 will preferably be attached to the reaction tube 1, also acting as the central axis of rotation for the gasifier, and another stationary set 16. The double set of propellers allows the material to enter the gasifier by containing the gases circulating in the gasifier. At least one lateral inlet 13 arranged tangentially at the top portion of the cylindrical portion 10 of the cyclonic reactor, allowing gas or plasma to be injected more or less tangentially to the wall. Plasma will be produced, for example, using plasma torches, operating with a gas or mixture of gases, a liquid or mixture of liquids, or any mixture of liquid and gas forming the plasma generation inlet fluid. In a particular embodiment, the plasma generation inlet fluid may, for example, be obtained from a mixed liquid comprising a mixture of water, oil, hydrocarbon and tar.
11) In a particular embodiment, the device will comprise, downstream of the point of entry of the plasma torch or torches, an orifice for injecting a fluid to be gasified, such that the fluid is composed of any mixture of water, hydrocarbon/oil, particles in suspension or tar, such that the trajectory of the fluid crosses the trajectory of the plasma so as to vaporise the fluid and/or atomise the fluid.
12) In a particular embodiment, the cyclonic gasification reactor comprises at least one waveguide 17 allowing to inject microwaves into the cyclonic gasification reactor. In a particular embodiment, the orientation of the waveguides FIG. 3-I.17 will be optimised so that the trajectory of the microwaves crosses that of the plasma FIG. 3-I.13 allowing the microwaves to interact with the plasma cloud injected by the plasma torches, while minimising the interaction with the column of gas rising in the cyclone. In this embodiment, the outlet of the waveguides into the reactor will be closed by a window made of quartz, zirconium, alumina or any other ceramic transparent to the microwaves such that the portion of the window integrated into the internal wall of the cyclonic reactor is preferably profiled to form a continuity with the wall of said reactor.

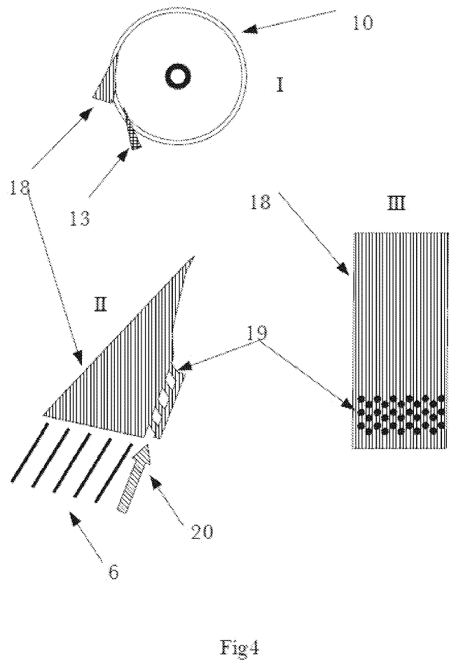

In some embodiments, the window will be set back from the wall of the reactor, such as the reactor having slits profiled opposite the window, such that the slits are spaced apart (between 9 mm and 2 cm, allowing microwaves to pass through) and the tangential passage of the gases creates a vacuum by the Venturi effect.
13) in a particular embodiment, a ceramic element having a system for regulating the temperature of said ceramic element will be introduced into the wall of the FIG. 4-I.18 reactor in order to fix this temperature at a predetermined level so as to transform this ceramic element into an adjustable black body emitting infrared radiation of a selected wavelength, such that the wavelength emitted by the black body is adjusted by controlling the temperature of the black body such that

λₘₐₓ=b/T
and

νₘₐₓ=T×58.8 Ghz K
where T=absolute temperature
b=2.8977729 10−3 Km,
thanks to the antagonistic action of a heating device and a thermal exchanger.

In one embodiment, the device for regulating the temperature of the black body will be a radiator 19 included in the black body operating with a gas 20, for example O2 or CO2, H2O vapour or a liquid H2O liquid, as a heat-transfer fluid.

In some embodiments, the cooling fluid for cooling the black body is injected into the cyclonic gasification reactor after cooling the black body, by passing through a radiator.

In other embodiments, the black body is cooled by a fluid such as water or any other heat-transfer fluid circulating in a radiator integrated into the black body.

In some embodiments, the black body is heated by the application of an electromagnetic radiation. In one embodiment, heating is achieved by applying a conditioned solar electromagnetic radiation into an optical fibre FIG. 3-II.6.

In some embodiments, the black body is made of a conductive material such as silicon carbide, zircon, zirconium or platinoids, and is heated by the application of microwaves or electromagnetic waves injected into the cyclonic reactor.

During operation, the black body will be heated to the desired temperature by the heat input from any combination of the heat from the fluids and particles circulating in the cyclonic gasification reactor, the heat from the chemical reactions produced inside the reactor, the action of any microwaves, and the action of light from the optical fibres.

The temperature of the blackbody will be stabilised at the desired electromagnetic emission temperature by balancing the heating of the black body by the cooling of the black body by its radiator or exchanger, the balance of the antagonists maintaining the black body at a stable temperature.

For example, an optical thermal probe or a thermocouple connected to an automaton, such as an Arduino, a micro-controller or any other automaton, allow to maintain the temperature of the black body at a target temperature by managing the flow rate of the cooling fluids and the levels of illumination and/or microwave exposure to which the black body will be subjected. Temperature management will involve, on the one hand, managing the opening and the closing of proportional or on/off valves and/or pumps and/or fans controlling the flow rate of the fluids for cooling the black body, and on the other hand, the power of the microwaves and/or the shutters or diaphragms; in general, all devices capable of controlling the light power and/or the microwave power to which the black body is exposed. The target temperature of the adjustable black body is obtained by combining the two antagonists heating/cooling of the black body.
14) In a particular embodiment, the adjustable black body is used to make a symmetrical molecule “without dipole moment” sensitive to a magnetic or electric field such as the field produced by the microwaves.

The sensitivity to a varying magnetic or electric field is achieved by subjecting the molecules to a radiation corresponding to the absorption frequency of one of their asymmetric modal vibration modes, creating a transient dipole. During the service life of the transient dipole, the molecule becomes sensitive to the magnetic field and orientates itself according to the field, creating kinetic heating of the molecules.
15) The main reactions carried out in the cyclonic gasification reactor will be:

C+H₂O→CO+H₂ b)

C+CO₂→2CO c)

C+½ O2→CO d)

The black body, for example, is used in reaction “c” to heat symmetrical CO₂ molecules using microwaves by adjusting the emission of the black body to 1500 cm⁻¹ in order to make the molecule asymmetrical by stretching, or 3000 cm⁻¹ to make the molecule asymmetrical by binding.

The adjustable black body can also be used to heat the O₂ molecule under the action of microwaves by making the molecule asymmetric at 2331 cm⁻¹.

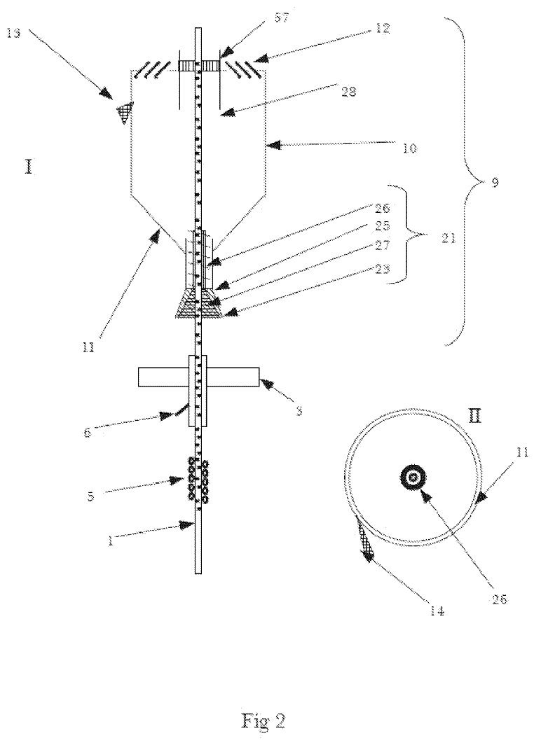

In general, the adjustable black body can be adjusted to the vibrational modes of other molecules involved as a function of the vibrational frequencies of the asymmetric vibrational modes.
16) In a particular embodiment, a material extractor FIG. 2-I.21 is introduced at the bottom of the cyclonic gasification reactor, at the summit of the conical portion, so that the sedimented particles, when the descending vortex converges into a column of rising gas, can be evacuated outside the reactor by limiting or preventing the exit of the gases through the cone of the cyclone.

In a particular embodiment, the extractor consists of a set of inclined vanes FIG. 3-IV.22 in the same direction of rotation of the descending vortex gases. As it descends, the kinetic energy of the vortex gas prevents it from passing through the vanes, while the gasified particles (clinker) or partially gasified particles (activated carbon) can exit the reactor through the space between the vanes.
17) In another preferred embodiment, the extractor is composed of a cylindrical mill FIG. 3-II.23 composed of a central hub FIG. 3-II.24 in the shape of a trapezium equipped with grooves, the depth of which forms an ellipse for example, the hub being set in a complementary cylinder FIG. 3-II.25 in the shape of a trapezium, equipped on the inner face with grooves, the depth of which forms an ellipse for example. The central hub is secured to the reaction tube FIG. 3-II.1, so that it rotates with the reaction tube.

As it rotates, the hub crushes the gasified particles (clinker), or partially gasified activated carbon, expelling them from the reactor.
18) In a preferred embodiment, the extractor comprises a endless screw conveyor such that the summit of the cone at the bottom of the cyclonic reactor comprises a cylinder FIG. 3-III.26, FIG. 2-I.26 in which an endless screw is arranged, the endless screw FIG. 3-III.27, FIG. 2-I.27 being secured to the reaction tube, which acts as the axis of rotation of the endless screw. As the endless screw turns, the gasified particles (clinker) or partially gasified particles (activated carbon) are discharged outside the reactor, depending on the speed of rotation of the reactor, which acts as the axis of rotation.
19) the extractor may be composed of any combination of inclined vanes, central hub mill, endless screw conveyor.

In particular, the extractor may consist of a combination of:
inclined vanes, screw conveyor, 22, 27
inclined vanes, central hub mill 22, 23
screw conveyor, central hub mill, 27, 23
inclined vanes, screw conveyor, central hub mill, 22, 23, 27
20) in a particular embodiment, the cyclonic gasification reactor has, in its first third, a central tube FIG. 1-I.28, to capture the gas rising in the centre of the cyclone. The central tube will serve as an axle for a set of fins forming the longitudinal inlet of the cyclone 14, such that the central tube is preferably secured to a first set of fins 14 and serves as an axis of rotation for a second set of fins 15, by means of a device allowing the rotation 28. The second set of fins 15 will be secured to the reaction tube 1 by means of an attachment allowing the passage of the gas, rising the cyclone between the central tube, the attachment structure of the second set of fins, for example a double propeller 29, will allow to make the connection while allowing the gas to pass, rising at the centre of the cyclone. The connecting propeller will be oriented in such a way that as it rotates, driven by the reaction tube, the double propeller will cause the gas in the gas column to rise towards the central outlet of the cyclonic reactor.
21) In a particular embodiment, the walls of the cyclonic gasification reactor will incorporate thermal exchangers, preferably cooled with water, but which can also be cooled by any fluid or mixture of gases and particularly any mixture of oxidising gases used in gasification such as CO, H₂O, CO₂.
22) In a preferred embodiment, the water vapour produced in the exchanger included in the wall of the cyclonic reactor, thanks to the heat recovered from the chemical reactions occurring in the cyclonic reactor, will be:
injected with the CO, produced in the cyclonic gasification reactor by the reaction “c”, and/or by the reaction “d”, optionally by the reaction “b” in the presence of H₂ or by a combination of the reactions “c”, “d”, “b”, such that the reaction “a” can occur in the reaction tube so as to convert the CO produced into CO2 and H2 under the action of the water vapour, of the heat and of the catalysts covering the inside of the tubular reactor.
Injected into the cyclonic gasification reactor through plasma torches.

24) In a preferred embodiment, the reaction tube included in the cyclonic gasification reactor in the axial position may be subjected to a radiation or to any combination of microwave, luminous, thermal or radioactive radiation, or to a varying electric and magnetic field by implanting devices allowing this radiation to be produced upstream or downstream of the cyclonic portion proper of the cyclonic gasification reactor.
25) In a particular embodiment, at the outlet of the reaction tube, the gas mixture is cooled to below 100° C., for example using the exchangers of an ORC cycle, allowing electricity to be produced in parallel.
26) in a preferred embodiment, the cooled mixture is bubbled in a reservoir saturated with hydroxy metal such as: X(OH)j and possibly containing X(HCO3)j forms,

The CO2 contained in the cooled mixture dissolves to form carbonates and hydrogen carbonates such as:

CO₂+H₂O→H₂CO₃ G1)

CO₃+OH→H—CO₃⁻

CO₂+H₂O→H—CO₃⁻+H⁺ G2)
and such that

X(OH)j+j(H₂CO₃)→X(HCO₃)j+j H₂O F3)
or

X(OH)j+jn(H—CO₃—)→Xn(CO₃)j+j H₂O F4)
or

X(OH)j+j(H—CO₃⁻)→X(CO₃)j+j H₂O F5)
such that “X” is taken from n+, d2+ and “j” is between 1 and 2.
with “n” chosen from (Li, Na, K)
“d” selected from (Mg, Ca, Be).
27) In a particular embodiment, the bubbling device is in the form of a sealed tank FIG. 4.30, comprising a sealed ramp FIG. 4.31, such that a conveyor belt 32 with filtering cleats 33 is arranged at the bottom of the tank 30 and rises in the sealed ramp 31. A tube 34 is placed at the end of the ramp so that when the belt passes the last roller, it can discharge the precipitates carried by the belt into the tube. A washing device 35 sprays the belt at the end of the ramp with a solution saturated with X(OH)j so that the washing water and the materials carried by the belt fall into the tube 34. A bubbling system 37 is positioned above the belt in the vessel, so that the mixture cooled to less than 100° C. from the tubular reactor bubbles above the belt into the tank. The solution 36 contained in the tank 30 is saturated with X(OH)j, thanks to a reservoir, confluent with the tank 39, containing crystals of X(OH)j, so as to produce a saturated solution. Under the action of X(OH)j, a precipitate is formed, for example X(HCO3)j for X=Na, K, Li or X(CO3)j for Ca or Mg. The precipitate is then driven by the belt into the ramp and spilled into the tube. The tube then opens to the inlet of a press 41 which compresses the precipitate and separates it from the solution. The solution is then returned to the reservoir 39 containing the crystals X(OH)j. The gas released after bubbling can be washed several times in this way to obtain 99.99% purified H2.
28) In one embodiment, any combination of the reactions “b”, “c” and “d” can be carried out concurrently in the same cyclonic gasification reactor. However, in a preferred embodiment, each of the three reactions is carried out separately in a multi-stage cyclonic gasification reactor.

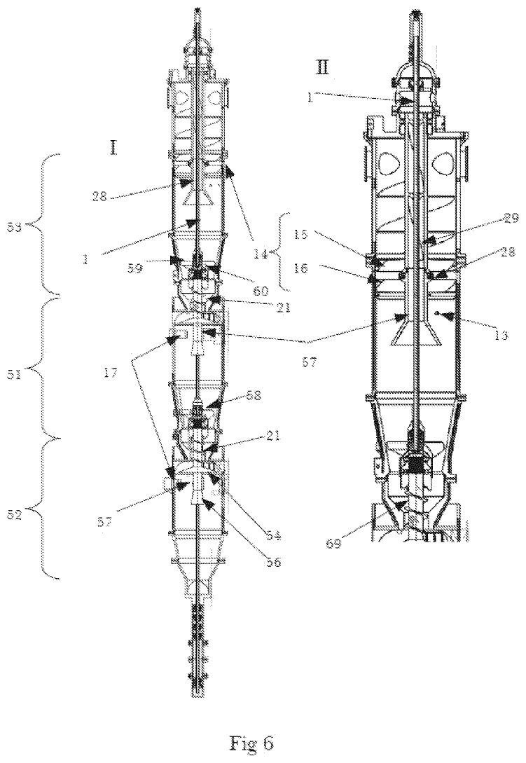

The reaction “d” is therefore specifically carried out by injecting pure oxygen into the reactor FIG. 6-I-53 using plasma torches FIG. 6-I-13.

By using an oxygen deficiency in a proportion of ½ O₂ to 1 carbon, and at a temperature above 700° C., preferably above 950° C. obtained by the action of the plasma torches and/or the injection of microwaves into the reactor or a combination of both, it is possible to produce essentially CO.

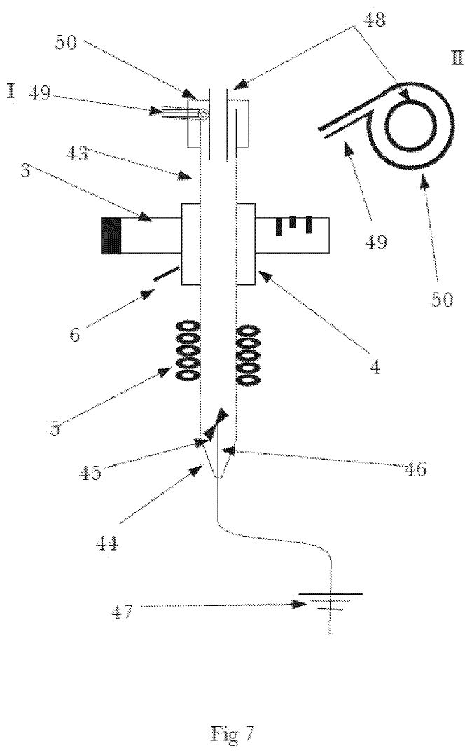

The CO will then be injected into the reaction tube with the water vapour produced to produce dihydrogen and CO₂.
29) In another embodiment, some of the CO is redirected towards a plasma cyclonic tube reactor FIG. 7, which allows the reaction “e” to be carried out

2 CO→CO₂+C e)
the reaction “e” being catalysed by the application of microwaves.

In a particular embodiment, a plasma cyclonic tube FIG. 7 comprising a tube of quartz 43, alumina, zirconia, borosilicate or any other material or ceramic transparent to the microwaves and permeable to an electric and magnetic field while being electrically insulating, with a diameter of between 1 cm and 10 cm, preferably 4 cm, is arranged through a waveguide FIG. 7.3, allowing microwaves to be applied inside the tube. Wave phase devices are arranged upstream and downstream of the plasma cyclonic tube, in particular the retractable bars allowing to modulate the phase of the incident wave and a movable bellows allowing to modify the phase of the reflected wave.

In a particular embodiment, the plasma cyclonic tube is located at the intersection of two waveguides spaced apart by an angle [symbol] , so that the waves coming from the magnetron of each waveguide are superimposed in such a way that, at the intersection of the waveguides, a harmonic wave is generated at the level of the reaction tube, amplified by the square of the intensity of the microwaves applied inside the reaction tube. In this embodiment, each waveguide has a movable bellows and bars allowing to adjust the phase of the incident and reflected waves.

The lower portion of the plasma cyclonic tube is closed by a cone 44 pierced with a hole through which passes an adjustable, retractable, electrically conductive axle 46. The axle will be made, for example, of graphite covered with a platinum metal, stainless steel possibly covered with gold or silver or any other conductive material. The axle will be surmounted by a thin propeller 45 made of conductive material of the same nature as the axle or any other conductive material.

In a particular embodiment, the axle and the fine propeller may be connected to earth 47. In a particular embodiment, the fine propeller will have a diameter equal to the cross-section of the rising gas column, so that as the gas rises it can rotate the fine propeller. The summit of the plasma cyclonic tube is formed by a cover 50, the internal edge of which is continuous with the inner face of the tube. An orifice is arranged tangentially to the wall of the cover 49 allowing a gas to be injected tangentially to the wall of the cover and that of the tube, so as to form a descending vortex. At the centre of the cover is a central collection tube 48, the internal diameter of which is equal to the size of the rising gas column, typically 33% of the internal diameter of the tube.

In a preferred embodiment, the plasma cyclonic tube is arranged in a containment cylinder FIG. 7-1.4 so as to pass through the waveguide or waveguides FIG. 7-1.3 transporting the microwaves.

In a particular embodiment, a solenoid FIG. 7-1.5 with typically 3-5 or 7 turns, preferably formed by the winding in turns of a conductive tube such as a copper tube covered with silver or gold and such that a heat-transfer fluid passes through the tube of the solenoid to cool it, the solenoid is connected to the terminals of a high frequency generator, for example between 800 kHz and 16 MHz.

All or part of the CO produced in the cyclonic gasification reactor is injected into the tangential inlet of the plug of the plasma cyclonic tube so that a downward vortex forms in the plasma cyclonic tube. At the bottom of the plasma cyclonic tube, under the action of the conical shape, the gases converge to form a column of gas rising to the centre of the plasma cyclonic tube. The adjustable axle and the fine propeller are ideally positioned so that the fine propeller is set in rotation by the upward flow of gas. With the axle connected to earth, the high-frequency electric field generated by the solenoid ignites a plasma in the column of gas rising to the centre of the tube, and possibly also in the vortex. The rotation of the fine propeller stretches each line of plasma flow so as to produce a gliding arc or Glid Arc. The plasma flow lines then ignite an intense plasma in the area of the tube subjected to the microwaves, so as to induce the condensation reaction of CO on itself to produce C and CO₂.

The carbon powder and the CO₂ forming an upward flow are then captured by the tube of the cover located in the centre of the quartz tube.

The CO₂/carbon particle flow is then rapidly cooled in a cyclone, comprising a particle filter, arranged on the collector tube at the centre of the cyclone, to capture the carbon powder and an exchanger and pipes in the walls of the cyclone to allow the cooling heat-transfer fluid to pass through.

A exchanger will also be installed on the outer portion of the central tube to the filtration cyclone. The heat-transfer fluid used can be the heat-transfer fluid of an ORC.
30) At the outlet of the filtration cyclone, the CO₂ produced can be attached using the method described in section 26.

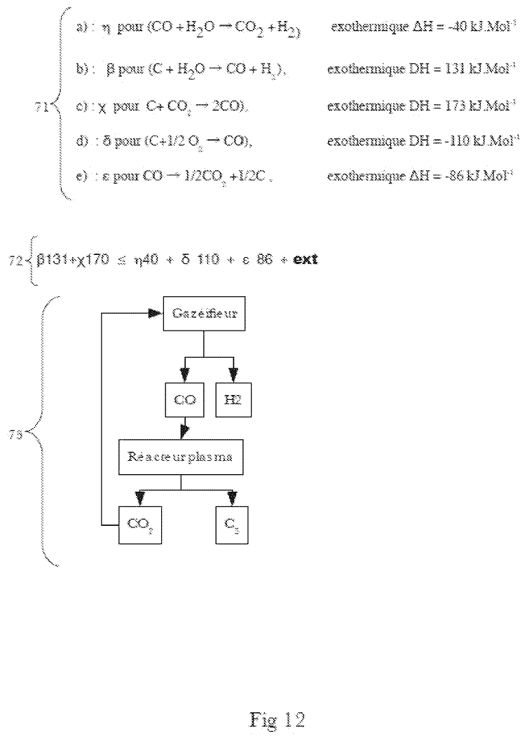

In another embodiment, CO₂ can be used as a catalyst for storing carbon from C in the form of carbon powder according to the cycle shown in FIG. 12.73, where the CO₂ is recycled by the cyclonic gasification reactor by combining the equations FIG. 12-71. In this case, the cyclonic gasification reactor will have a cyclonic stage specific to the reactions a, b, c and d.

Within the scope of the equations in section 26) CO₂ can be considered as a catalyst for the storage of carbon of the CO₂, by combining the equations “c” and the equations “F3” with the equations “S”
such that:

X(HCO₃)j→X(CO₃)j/2+(H₂O)j/2+CO₂ S1:

2 X(HCO3)→X2CO₃+CO₂+H₂O S2:
such that “X” is taken from n+, d2+ and “j” is between 1 and 2.
with “n” chosen from (Li, Na, K)
“d” selected from (Mg, Ca, Be)
using the same principle, mixed situations can be created by combining different reactions.
31) In a particular embodiment, the cyclonic reactor can be a multi-stage cyclonic reactor, typically a three-stage cyclonic reactor, 51, 52, 53 with one stage dedicated to each of the reactions:

C+H2O→CO+H2, Cf FIG. 7-1.51 b)

C+CO2→2CO, for Cf FIG. 7-1.52 c)

C+½O2→CO, for 43 FIG. 7-1.53 d)
the reaction “a” of gas to water being produced in the axis formed by the reaction tube FIG. 7-1.1 passing through the Cyclones and also acting as the axis of rotation.
32) In this particular embodiment, the transition between two cyclonic stages of the cyclonic gasification reactor is carried out by a set of fins surrounding a tube, said tube being the collector tube FIG. 3-IV.54 of the lower cyclone rising in the conical portion of the upper cyclone, such that the gases rising in the centre of the lower cyclone can rise in the central portion of the upper cyclone by juxtaposing or mixing with the gases of the rising column of the upper cyclone.

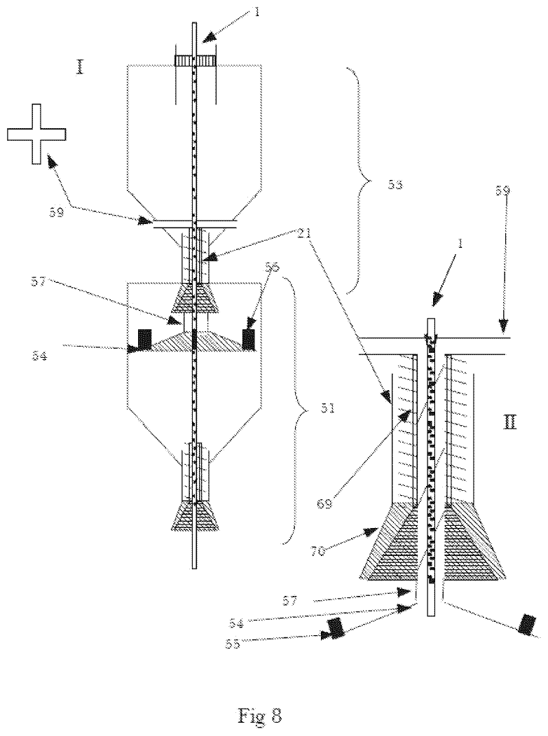

In this configuration, the fins FIG. 3-IV.22 prevent the gases descending from the vortex of the upper cyclone of the cyclonic gasification reactor from passing to the lower cyclone, while the central tube allows the upward flow of gases to pass through all the cyclones of the reactor.
33) In a particular embodiment, an extractor will be arranged between two cyclones or stages of the cyclonic gasification reactor FIG. 6-I.21. In this embodiment, the propeller or endless screw of the extractor FIG. 8-II.21 and/or the central hub of a mill will be hollow and secured to the central tube for collecting the gases rising in the centre of the lower cyclone, the reaction tube FIG. 8-II.1 forming an axis of rotation secured to the endless screw of the extractor and/or with the central hub of the mill, such that the gases rising from the second cyclone or lower cyclone can pass between the external surface of the reaction tube and the internal surface of the endless screw or lumen of the endless screw and/or of the central hub of the mill. The materials being gasified and/or the clinker can be transported from the upper cyclone to the lower cyclone by the action of the thread of the endless screw.
34) in a particular embodiment at the end of the endless screw of the extractor, a skirt will be arranged FIG. 8-II.54, FIG. 6-I.54 from the edge of the endless screw, up to at most 1 cm from the edge of the cyclone of the cyclonic gasification reactor. This skirt allows the material from the upper cyclone to be directed around the periphery of the lower cyclone, so that the material from the first cyclone is directed into the downward gas vortex of the lower cyclone.

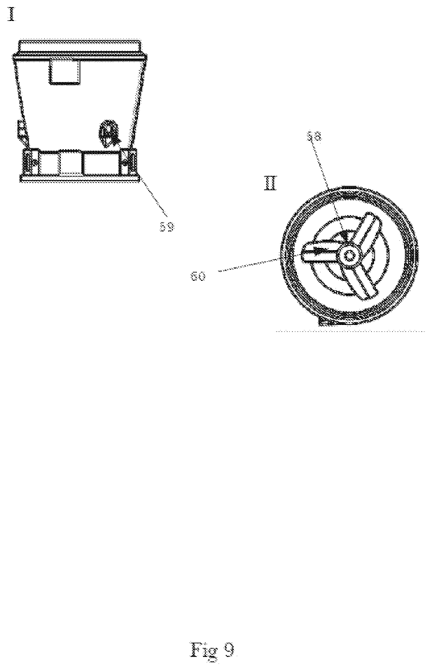

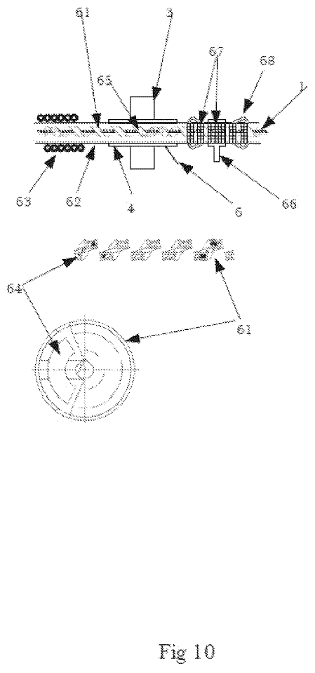

In a particular embodiment, repeated vertical blades FIG. 8-II.55 are arranged at the edge of the skirt FIG. 8-II.54 in order to break any vortex upwelling.
35) In a particular embodiment, a collection cone FIG. 6-I.56 may be arranged at the end of the collector tube FIG. 6-I.57 for collecting the gas flows rising to the centre of the cyclones of the cyclonic gasification reactors, the size of the cone allows to modulate the residence time of the particles introduced into the gasifier.
36) In other embodiments, the collector tube FIG. 6-I.57, FIG. 8-II.57 of the lower cyclone, confluent with the endless screw of the extractor FIG. 6-I.21, FIG. 8-II.21 of an upper cyclone, will be closed at its upper end by a cap FIG. 6-I.58, FIG. 9-II.58, forming a plug with a system of conduits FIG. 6-I.59, FIG. 8-II.59, FIG. 9-1.59, the vanes FIG. 9-II.60 of the plug are hollow and open at one of their ends into the lumen of the collector tube FIG. 6-I.57, FIG. 8-II.57 and at the other of their ends to the outside of the gasifier so that the gases rising from the lower cyclone are captured by the collector FIG. 6-I.57, FIG. 8-II.57 and conducted through the vanes towards a capture point outside the cyclone.
37) In a particular embodiment, a linear reaction tube FIG. 10-I.1 with a size of between 1 m and 10 m and an inner diameter of between 5 mm and 50 mm is secured to a propeller or hollow-walled coreless endless screw FIG. 10.61, such that the reaction tube forms the axle of the coreless endless screw. The propeller and the reaction reactor are then encased in a gasification reactor tube FIG. 10-I.62. The outer wall of the linear tube gasification reactor comprises thermal exchangers FIG. 10-I.63., such that a heat-transfer fluid, preferably the oxidising fluid used for the gasification, circulates in the exchanger, so that said fluid is heated by the gasification reaction taking place in the linear tube gasification reactor. The heat-transfer fluid is then injected into the hollow walls of the endless screw FIG. 10.64. Holes pierced at regular intervals in the hollow walls of the endless screw FIG. 10-I.65 allow the oxidising fluid to be distributed evenly throughout the tube gasification reactor. Waveguides FIG. 10-I.3 are regularly arranged, perpendicular to the main axis, along the linear tube gasification reactor, in regions where the tube gasification reactor is made of a material transparent to the microwaves, such as ceramic quartz of zirconium, alumina, possibly the reaction tube forming the axle of the coreless endless screw is also made of a material transparent to the microwaves. The microwaves, produced by magnetrons for example, are thus injected into the linear tube gasification reactor and possibly into the reaction tube. The waveguides may be accompanied by tuning devices with movable pistons and retractable cylinders.
38) In a particular embodiment, optical fibres FIG. 10-I.6 are regularly arranged along the linear tube gasification reactor, close to the waveguides, so as to inject electromagnetic radiation, preferably visible, UV or infrared light, onto the wall of the linear tube gasification reactor and possibly into the reaction tube reactor. In a preferred embodiment, the optical fibres are inserted non-perpendicular to the linear tube gasification reactor. In one embodiment, the pores or hole 65 in the wall of the hollow endless screw are arranged opposite the waveguides so that the oxidation fluid is directly exposed to the magnetron at the outlet of the endless screw.
39) After each magnetron and optical fibre a gas extraction unit FIG. 10-I.66 is implanted in the linear tube reactor, such that each gas extraction unit comprises a cylindrical filter FIG. 10-I.67 isolated upstream and downstream by a system of Tesla valves FIG. 10-I.6 mounted in opposition.

Each Tesla valve is formed by a series of cup-handle tubes, arranged on the wall of the linear tube gasification reactor circularly around a section of the linear tube gasification reactor. Several rows of cup handles form a Tesla valve. In some embodiments, the cup-shaped tubes of a Tesla valve are arranged in one or more helical generatrixes. The opposing or antagonistic valves are obtained using cup-handle tubes, where the bent portion of the cup-handle tubes have opposite directions from one valve to the other. In this way, the oxidation gas is evenly diffused between the two antagonist valves in the linear tube gasification reactor, diffuses little and, under the action of microwaves and possibly other electromagnetic radiation, reacts with the carbon substrate locally to produce the gasification reaction but the syngas produced (any proportion of CO and H₂) and the oxidising gas diffuse slowly through the reactor under the action of the opposing Tesla valves to reach the filter of the extraction unit, leaving time for all the oxidising gas to react. At the level of the extraction unit, the tesla antagonist/opposite valves trap the gas at the level of the cylindrical filter, by displacement thanks to the cup-shaped handles arranged in opposition between two tesla valves surrounding the cylindrical filter, long enough to allow it to be extracted. Syngas diffusion is slowed down considerably at the level of the extractors so that it can be pumped, sucked through the cylindrical filter or collected by passive diffusion. The substrate conveyed by the coreless endless screw will convey the substrate along the linear tube gasification reactor, passing successively in front of the waveguides and the optical fibres causing the successive gasification, then in front of an extractor allowing the gases produced to be evacuated.
38) in certain embodiments, the fluid circulating in the exchanger 63 of the linear tube gasification reactor may be hot water, in particular hot water circulating in a nuclear power plant circuit. For example, pressurised water from the primary water circuit of a non-exhaustive REP or EPR nuclear power plant, after the passage of this water through the thermal exchanger of the secondary circuit driving the turbine.

The water then passes through the exchanger of the linear tube gasification reactor. The residual heat of the pressurised water remains sufficient to initiate or reduce the energy input required to initiate the gasification reactions, in particular the exothermic reaction “d”, in this geometry, the water from the exchangers and the oxidising gasification fluids will be separate.

As a result of the auto-thermal and exothermal reaction “d”, the water leaving the exchanger of the linear tube gasification reactor will be hotter than at its inlet and can be used to generate a new vapour cycle or be used in another ORC cycle.

In certain embodiments, heated pressurised water can be returned to the inlet of the exchanger between the primary and secondary circuits of the nuclear power plant to improve the vapour cycle.

This approach allows to design a non-polluting combined nuclear/biomass/coal system that allows coal or dihydrogen production to be exploited without reducing the performance of the nuclear power plants in terms of electricity production.

### Example/Description of a Mode for Implementing the Invention

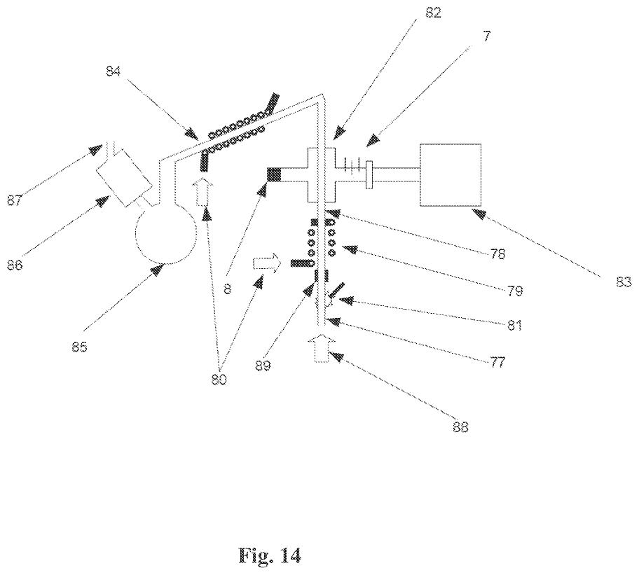

FIG. 14 and the description that follows relate to an example that illustrates the invention and demonstrates how the invention works.

A quartz tube 78 with an outer diameter of 40 mm, an inner diameter of 37 mm and a length of 500 mm is joined to a silicon carbide tube 77 with an outer diameter of 40 mm, an inner diameter of 37 mm and a length of 1,000 mm, the two tubes being held together by a zirconium ring 89 with an outer diameter of 44 mm, an inner diameter of 40 mm and a length of 10 mm.

The quartz portion 78 of the tube is arranged at the centre of a focusing device of the Sairem® brand, referred to as down stream 82, comprising a brass tube drilled to 42 mm in diameter and having a movable piston 8 of the mirror sliding piston type for example, and adjustment systems of the obstacle piston type for example, referred to as stabs 7, allowing the phase of the microwaves to be controlled so as to create a constructive wave of microwaves at the centre of the quartz tube.

The down stream 82 is coupled to a Sairem® 2.45 GHz 83 microwave source with a maximum power of 2 MW, allowing microwaves to be applied to the quartz tube 78, with the piston 8 and the stabs 7 allowing to centre the microwaves at the centre of the quartz tube.

The microwave generator is set to 1 MW.

Below the down stream 82, a four-turn solenoid 79 is arranged around the quartz tube 78, consisting of a copper tube of 10 mm in diameter, so as to form a solenoid of 100 mm high, and a cooling liquid 80. Demineralised water circulates through the tube of the solenoid 79, allowing to cool it.

The ends of the solenoid are connected to a Cesar® 13.56 MHz high-frequency electrical generator delivering a maximum current of 4 kV at a maximum current of 0.5 A, giving a power of 2 MW. The power is set at 1 MW.

The quartz tube and solenoid assembly is housed in a 400×400×400 mm tuning box, allowing to reduce the variations in the impedance of the assembly.

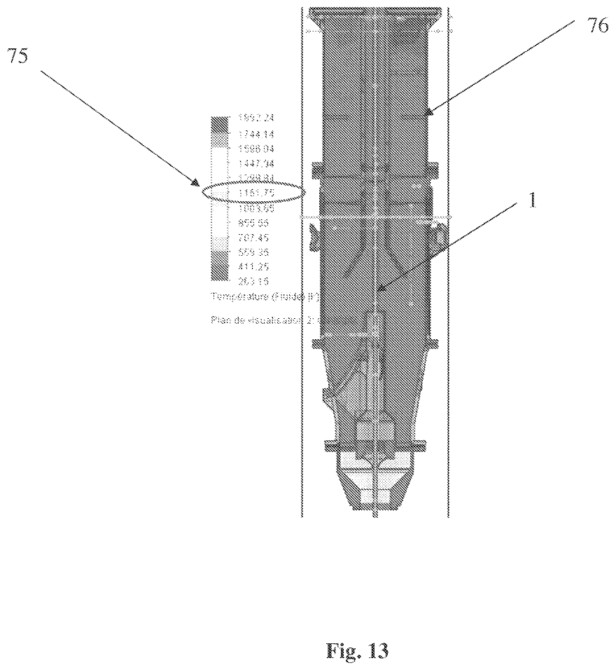

The silicon carbide tube 77 is maintained at a temperature of 800° C. by the flame of a torch 81 which supplies thermal energy through the wall of the silicon carbide tube 77, mimicking the action of the centre of a cyclonic gasifier 76 (FIG. 6 and FIG. 13).

The temperature at the centre of a cyclonic gasifier between 500° C. and 2000° C. was determined by thermal and fluid modelling using SolidWorks® software.

Initially, a mixture 88 of gas ½ water vapour, ½ CO at a flow rate of between 5 and 10 l/min at atmospheric pressure is introduced through the inlet of the silicon carbide tube 77 so as to pass through the silicon carbide tube and then the quartz tube.

A wired plasma torch is then formed in the quartz tube at the level of the solenoid 79 and intensifies at the level of the down stream 82 under the action of the microwaves.

A water cooler 84 is installed at the top outlet of the quartz tube allowing to condense the water vapour remaining in the gas after it has passed through the carbide and quartz tubes 78. At the outlet of the cooler is arranged a flask 85 allowing to collect the gases and any liquids leaving the refrigerator.

At a CO/H2O gas flow rate of between 5 and 10 l/min, no liquid is collected in the flask, and the analysis of the gas collected in the flask by a CO detector 86 does not indicate the presence of CO in the outgoing gas. All the CO and H2O have reacted.

Above 10 l/min, drops of condensation form in the flask indicating the presence of water in the effluent from the quartz tube 78 and the analysis of the gas collected in the flask by a CO detector 86 indicates the presence of CO.

The presence of water and CO is also revealed when the magnetron 83, the high-frequency generator inducing a magnetic field induced in the solenoid 79, and the thermal heating torch 81 are switched off.

In another example of embodiment, a spray of liquid water 88 is introduced into the silicon carbide tube. The liquid water in spray form is driven by a gas CO engine at a flow rate of 2.5 and 5 l/min of CO, with the spray nozzle set to pulverize between 2.25 g and 4.5 g of water/min.

In this operating range, no liquid is collected in the flask 85, and the analysis of the gas collected in the flask by a CO detector 86 does not indicate the presence of CO.

The inventors have therefore demonstrated the feasibility, the reproducibility and the operation of the device according to the invention.

### LEGENDS FOR ALL FIGURES

1—reaction tube
2—obstacle in the reaction tube
3—waveguide
4—containment cylinder for the microwaves and the visible, UV and infrared radiations
5—solenoid in which an alternating current circulates
6—optical fibre
7—adjustment bars for adjusting the phase of the wave
8—movable piston tuning of wave reflection
9—cyclonic gasification reactor
10—cylinder forming the body of the cyclone of the gasifier
11—cone of the cylinder forming a gasifier
12—longitudinal inlet of the cyclonic reactor
13—tangential inlet of the cyclonic reactor for plasma torch
14—longitudinal inlet with a double set of fins of the cyclonic reactor,
15—movable set of double set of fins of the cyclonic reactor
16—fixed clearance of the double set of fins of the cyclonic reactor
17—waveguide for injecting microwaves into the cyclonic gasification reactor
18—ceramic element with a system allowing to regulate the temperature forming an adjustable black body
19—radiator included in the black body
20—cooling fluid for the black body
21—material extractor
22—set of inclined vanes
23—cylindrical mill
24—trapezoidal central hub equipped with grooves
25—complementary cylinder of the central hub
26—endless screw cylinder for extractor
27—material extractor endless screw
28—device allowing the rotation between the two sets of propellers of the longitudinal inlet
29—double propeller connecting the movable vanes of the longitudinal inlet to the reaction tube
30—sealed tank containing a solution saturated with hydroxy-metal
31—sealed ramp of tank saturated with hydroxy metal
32—conveyor belt
33—filter cleats
34—recovery hose for recovering the precipitates
35—washing device for washing the conveyor belt
36—solution saturated with hydroxy metal
37—CO₂-rich gas bubbling system
38—CO₂-rich gas
39—pressurized reservoir containing crystals of hydroxy metal in saturated solution
40—filter
41—filter press
42—pump
43—quartz tube
44—pierced cone
45—thin propeller made of conductive material
46—adjustable and retractable axle, electrically conductive
47—earth
48—collector tube collecting cover of plasma cyclonic tube
49—tangential orifice in the wall of the plasma cyclonic tube cover
50—plasma cyclonic tube cover
51—gasifier stage
52—gasifying stage
53—gasifying stage
54—skirt
55—vertical blades arranged along the edge of the skirt
56—collection cone arranged at the end of the collector tube
57—collector tube
58—cap/plug
59—conduit of the cap
60—hollow vanes of cap forming conduits
61—propeller or hollow-walled coreless endless screw
62—gasification reactor tube
63—thermal exchanger of the linear tube gasification reactor
64—hollow wall of the endless screw of the linear tube gasification reactor
65—holes pierced at regular intervals in the hollow wall of the endless screw of the linear tube gasification reactor
66—extraction unit of the linear tube gasification reactor
67—cylindrical filter
68—Tesla valve consisting of a series of cup-shaped tubes and two cylindrical filters
69—hollow endless screw
70—hollow central hub mill
71—reaction a,b,c,d,e
72—energy balancing of the reaction combination (a,b,c,d,e) with EXT: external energy: solar, nuclear, geothermal or any other energy source
73—cycle of the carbon for recycling CO₂ and producing H₂
74—endless screw or slide for feeding the tangential inlet, possibly movable and coupled to the reaction tube 1.
75—operating temperature of a cyclonic gasifier
76—gasification reactor/cyclonic gasifier—SolidWorks® thermal modelling
77—Silicon carbide reaction tube
78—Quartz reaction tube
79—solenoid cooled water
80—cooling water
81—thermal heating flame
82—down Stream
83—magnetron
84—cooler
85—flask
86—CO detector
87—Gas outlet
88—inlet CO/H2O gas mixture or Spray H20 with CO engine gas
89—zirconium-ceramic junction

1. A device for producing dihydrogen from CO and H₂O, according to the gas-water reaction:
CO+H₂O→CO₂+H₂, (a)
characterised in that it comprises:
a reaction tube in which a gas mixture comprising CO and H2O is intended to circulate, this reaction tube having a diameter of between 5 mm and 500 mm, and a length of between 50 mm and 10 m,
a first gasification reactor in which the reaction tube is disposed so as to subject the reaction tube to a first thermal energy generated in operation by the first gasification reactor, and
at least one device for subjecting the reaction tube to at least one second electromagnetic energy, chosen from an electromagnetic radiation ranging from gamma rays to radio waves above 500 kHz, a radiation in the visible infrared and ultraviolet waves, a gamma radiation, a microwave radiation and a nuclear radiation such as alpha and beta.

2. The device according to claim 1, characterised in that the reaction tube comprises at least one portion preferably made of quartz, borosilicate glass, refractory metal such as inconel, nickel or any other refractory metal, ceramics such as carbide for example silicon, iodide, zirconia carbide.

3. The device according to claim 1, characterised in that the inside of the reaction tube comprises on its internal surface catalysts configured to catalyse said reaction (a), such that these catalysts comprise metals chosen from: iron in oxide form, Fe+, Fe2+, Fe3+, titanium in oxide form, cobalt in oxide form, nickel in oxide form, platinoids and platinoid oxides, and a combination of these metals.

4. The device according to claim 1, characterised in that the reaction tube comprises an internal lumen in which is arranged a set of obstacles, possibly covered with catalysts, preferably arranged perpendicularly to the main axis of the reaction tube, such that, by circulating in the lumen of the reaction tube, a CO/H₂O mixture comes into contact with these obstacles, promoting the reaction of the gas with the water.

5. The device according to claim 1, characterised in that it comprises at least one waveguide configured to inject microwaves produced by a magnetron into the reaction tube in order to promote said water-gas reaction (a) by a thermal and molecular agitation action.

6. The device according to claim 1, characterised in that it comprises at least one optical fibre preferably comprising a quartz or borosilicate portion, and configured to apply to the surface of the reaction tube or directly inside the reaction tube, an electromagnetic radiation between the ultraviolet and the infrared, in order to activate said reaction (a) by increasing the temperature of the reaction tube.

7. The device according to claim 1, characterised in that it comprises a solenoid with 3 to 7 turns, in which an alternating current of between 800 kHz and 20 MHz is intended to circulate, and configured to subject the reaction tube to an inductive electric and magnetic field, and to produce a reaction plasma in the CO/H₂O gas passing through the reaction tube, in order to promote said reaction (a).

8. The device according to claim 3, characterised in that the reaction tube is disposed in a device combining at least two of the devices selected from below, and allowing any combination of microwave, light wave and inductive magnetic field application to the reaction tube:
at least one waveguide configured to inject microwaves produced by a magnetron into the reaction tube,
at least one optical fibre configured to apply an electromagnetic radiation in the ultraviolet to infrared range to the surface of the reaction tube or directly inside the reaction tube,
a solenoid with 3 to 7 turns, in which an alternating current of between 800 kHz and 20 MHz is intended to circulate, and configured to subject the reaction tube to an inductive electric and magnetic field, and to produce a reaction plasma in the CO/H2O gas passing through the reaction tube.

9. The device according to claim 1, characterised in that said gasification reactor is a cyclonic reactor which is configured in such a way that the radiative thermal heat of the cyclonic gasification reactor, originating from at least one of the gasification reactions:
C+H₂O→CO+H₂ (b)
C+CO₂→2CO (c)
C+½ O₂→CO (d)
heats said reaction tube, and such that the cyclonic gasification reactor comprises:
at least one cylinder, forming the body of the gasification reactor, which narrows into a cone at the bottom of the gasification reactor, such that the gases injected into the gasification reactor form a vortex descending along the cylindrical wall of the cyclone, said vortex, by convection under the action of the conical shape of the bottom of the cyclone, rising at the centre of the cyclone,
a cyclonic device with at least two inlets, one longitudinal and one tangential, and
at least one extraction device for extracting materials in the conical portion at the bottom of the cyclone.

10. The device according to claim 1, characterised in that said reactor comprises at least one longitudinal inlet comprising a double set of propellers, preferably a first set of movable propellers attached to the reaction tube and configured to act as a central axis of rotation for the cyclonic gasification reactor, and another set of stationary propellers, the double set of propellers allowing the materials to enter the cyclonic gasification reactor by confining the gases circulating in the cyclonic gasification reactor.

11. The device according to claim 1, characterised in that the gasification reactor comprises:
at least one waveguide allowing to inject microwaves into the gasification reactor, and
at least one plasma torch in the gasification reactor, such that the orientation of said at least one waveguide (FIG. 3-I) is optimised so that the trajectory of the microwaves crosses that of the plasma injected into the gasification reactor by at least one plasma torch, allowing the microwaves to interact with the plasmas injected by said at least one plasma torch, while minimising the interaction with a column of gas rising in the gasification reactor.

12. The device according to claim 1, characterised in that it further comprises an extraction device comprising any combination of an endless screw, a central hub mill, a hollow endless screw, a hollow central hub mill, and alternatively any combination of a collector tube and vanes optionally hollow, and a cap forming a plug with a system of conduits.

13. The device according to claim 1, characterised in that an element is introduced at the level of a wall of the gasification reactor, this element preferably being made of ceramic and having a system allowing to regulate the temperature of the ceramic in order to set its temperature at a determined level so as to transform said ceramic into an adjustable black body emitting an infrared radiation of a selected wavelength, and in that the wavelength emitted by the black body is adjusted by controlling the temperature of the black body by a heating device and a cooling thermal exchanger.

14. The device according to claim 1, characterised in that at least one wall of the gasification reactor incorporates at least one thermal exchanger, cooled by a fluid such as water or a mixture of gasification oxidising gases such as H₂O, CO₂, O₂.

15. The device according to claim 14, characterised in that said at least one thermal exchanger is configured to produce oxidizing vapours, which are, together with the products of the gasification from said reaction (b), (c), and (d), injected into the reaction tube so as to convert the CO produced into CO₂ and H₂.

16. The device according to claim 1, this device allowing to inject a gas comprising CO into a plasma reactor in order to carry out a reaction:
2 CO→CO₂+C, (e)
characterised in that the reactor is a plasma cyclonic tube, and comprises:
a tube transparent to the microwaves, permeable to an electric and magnetic field, and electrically insulating, such as quartz, alumina, zirconia, borosilicate, iodide, this tube having a diameter of between 1 cm and 10 cm, and preferably 4 cm,
at least one waveguide allowing to apply microwaves inside the tube transparent to the microwaves,
in the lower portion of the tube transparent to the microwaves, a cone pierced with a hole through which an axle can pass,
an adjustable electrically conductive axle, such as graphite coated with a platinum metal, or stainless steel, and optionally coated with gold or silver,
a fine propeller made of conductive material, with a diameter equal to the cross-section of the gas column rising in the plasma cyclonic tube, and typically having a diameter corresponding to 33% of the internal diameter of the tube, this fine propeller being intended to be electrically connected to earth temporarily,
in the top position of the tube, a cover whose internal edge is continuous with the inner wall of the tube transparent to the microwaves, this cover having an orifice tangential to the inner wall of the cover allowing a gas to be injected tangentially to said wall of the cover,
in the centre of the cover a central collection tube whose internal diameter is intended to be equal to the size of the rising gas column, and typically having a diameter corresponding to 33% of the internal diameter of the tube transparent to the microwaves, and
a solenoid preferably having between 3 and 7 turns, which is connected to the terminals of a high-frequency generator, for example between 800 kHz and 20 MHz.

17. The device according to claim 1, characterised in that it comprises:
a collector tube of the gasification reactor,
a hollow endless screw of an extractor of a second reactor located above the first reactor is closed at its top end by a cap forming a plug with a system of conduits also forming the bottom of the second reactor,
hollow vanes arranged around the tube, confluent with the endless screw, and opening at one of their ends into the tube and at the other of their ends to the outside of the second reactor so that the gases rising from the first reactor are captured and conducted through the vanes towards a reservoir on the outside.

18. The device according to claim 1, characterised in that the reaction tube is secured to a hollow-walled propeller or to a coreless endless screw, such that the reaction tube forms the axle of the propeller or of the endless screw, this propeller or endless screw and the reaction tube being embedded in the gasification reactor, and in that the outer wall of the gasification reactor comprises at least one thermal exchanger, such that a heat-transfer fluid, preferably the oxidising fluid used for the gasification, circulates in said at least one exchanger so that said fluid is heated by gasification reactions occurring in the gasification reactor, and such that in a preferred embodiment the heat-transfer fluid at the outlet of the at least one exchanger is injected into the hollow walls of the propeller, which is pierced by holes to allow the heat transfer fluid to be diffused opposite waveguides regularly arranged more or less perpendicularly to the main axis of the gasification reactor, in regions where the gasification reactor is made of a material transparent to microwaves, such as ceramic quartz of zirconium, nitride, alumina, and in a preferred embodiment the reaction tube forming the axle of the propeller or of the endless screw is also made of a material transparent to microwaves.

19. The device according to claim 1, characterised in that optical fibres are regularly arranged along the gasification reactor, close to waveguides, so as to inject electromagnetic radiation, preferably light such as UV, visible light or infrared light, onto and preferably into the gasification reactor and onto and into the reaction tube.

20. The device according to claim 1, characterised in that it comprises a gas extraction unit implanted in the gasification reactor after at least one waveguide and optionally after a set of optical fibres, each gas extraction unit comprising at least one cylindrical filter isolated upstream and downstream by a system of tesla valves mounted in opposition.
